(19) United States
(12) Patent Application Publication
(10) Pub. No.: US 2012/0236163 A1
(43) Pub. Date: Sep. 20, 2012

(54) PHOTOGRAPHY DEVICE, PHOTOGRAPHY METHOD, AND PROGRAM

(75) Inventor: Tomokazu Teruya, Kanagawa (JP)

(73) Assignee: PANASONIC CORPORATION, Osaka (JP)

(21) Appl. No.: 13/497,899

(22) PCT Filed: Sep. 16, 2010
(86) PCT No.: PCT/JP2010/005671

§ 371 Date: Mar. 23, 2012

(30) Foreign Application Priority Data
Sep. 30, 2009 (JP) 2009-228281

(51) Int. Cl. H04N 5/225

(52) U.S. Cl. 348/207.99; 348/E05.024

(57) ABSTRACT

A photography device can perform a continuous shooting operation. The photography device includes: an image determination unit configured to determine whether determination values of a plurality of determination elements for images input by an image input unit are equal to or higher than determination threshold values of the plurality of determination elements; a continuous shooting stopping control unit configured to stop the continuous shooting operation if the image determination unit determines that the determination values of the determination elements are equal to or higher than the respective determination threshold values; and a determination threshold value correction unit configured to decrease the determination threshold value of the corresponding determination element if the image determination unit determines that the determination value of any of the determination elements is lower than the determination threshold value of the corresponding determination element.

### TECHNICAL FIELD

The present invention relates to a photography device having a continuous shooting function, a photography method, and a program thereof.

### BACKGROUND ART

Conventionally, a photography device having a continuous shooting function capable of continuously shooting images by once pressing down of a shutter button is known. As an example of the photography devices having such a continuous shooting function, there is known a photography device that continuously performs a photographing operation until an image satisfying a predetermined condition is photographed when a continuous shooting mode is set, and finishes the continuous shooting operation (e.g., see Patent Document 1). In addition, as another example of the photography devices, there is known a photography device that can lower a determination threshold value for detection of a smiling face with the lapse of continuous shooting time (e.g., see Patent Document 2).

### RELATED ART DOCUMENTS

### Patent Documents

Patent Document 1: JP-A-2008-078712

Patent Document 2: JP-A-2008-311819

### SUMMARY OF THE INVENTION

### Problem to be Solved by the Invention

However, by a technique of Patent Document 1, in a case where an image satisfying a predetermined condition is not obtained, the continuous shooting operation is not finished so that much time is spent or much electric power is consumed, thereby causing the continuous shooting function to be a function with less usability. In addition, by a technique of Patent Document 2, the continuous shooting operation can be finished at a desired timing by lowering a determination threshold value for detection of a smiling face. However, in a case where there are a plurality of determination criteria, when determination threshold values of the determination criteria are uniformly lowered, a finally obtained image may have low quality.

The invention is made in view of the above circumstances, and an object thereof is to provide a photography device, a photography method, and a program, which have a user-friendly photography function and which can prevent degradation of quality of a finally obtained image.

### Means for Solving the Problem

According to the present invention, there is provided a photography device capable of performing a continuous shooting operation, including: a continuous shooting start instruction unit configured to instruct start of the continuous shooting operation; an image input unit configured to input images at the continuous shooting operation; an image determination unit configured to determine whether determination values of a plurality of determination elements for images input by the image input unit are equal to or higher than determination threshold values of the plurality of determination elements; a continuous shooting stopping control unit configured to stop the continuous shooting operation if the image determination unit determines that the determination values of the determination elements are equal to or higher than the respective determination threshold values; and a determination threshold value correction unit configured to decrease the determination threshold value of the corresponding determination element if the image determination unit determines that the determination value of any of the determination elements is lower than the determination threshold value of the corresponding determination element.

In accordance with the above configuration, the continuous shooting function is user friendly, and degradation of quality of an image lastly photographed can be prevented. For example, with respect to a photographic object which hardly becomes a smiling face, only the determination threshold value for detection of a smiling face is gradually decreased. However, it is possible that the determination threshold values of other determination elements such as detection of camera shake and detection of a front orientation and the like are not decreased. Therefore, it is possible to prevent degradation of quality of a best shot which may be caused by decreasing the determination threshold values of the determination elements of which the determination values are higher than the determination threshold values.

In the photography device according to the invention, if the image determination unit determines that the determination value of any of the determination elements is lower than the determination threshold value of the corresponding determination element, the determination threshold value correction unit increases the determination threshold value of the determination element other than the corresponding determination element.

In accordance with the above configuration, for example, in a case where a determination value of a smiling face degree finally becomes equal to or higher than a determination threshold value whereby the detection of a smiling face is achieved, when the determination values are higher than criteria which are higher than initial setting values of the determination threshold values with respect to other detection elements initially having margins such as detection of camera shake, detection of a contrast and the like, it is possible to more improve the quality of the best shot.

In the photography device according to the invention, the continuous shooting stopping control unit stops the continuous shooting operation if the determination threshold value increased by the determination threshold value correction unit is equal to or higher than an upper limit threshold value of the determination element of the corresponding determination threshold value.

In accordance with the above configuration, even in a case where a determination value of a predetermined determination element is lower than the determination threshold value, when an extremely large determination value is obtained with respect to another determination element, a best shot excellent in overall quality can be obtained. In a case where, for example, a baby who hardly keeps his or her eyes front is to be photographed, a determination threshold value of determination of full-faced pose is gradually decreased. On the other hand, in a case where an extremely high smiling face degree is obtained, a best smiling face can be obtained as a best shot even when the baby does not keep his or her front.

According to the present invention, there is provided a photography method capable of performing a continuous shooting operation, including: a step of instructing start of the continuous shooting operation; a step of inputting images at the continuous shooting operation; a step of determining whether determination values of a plurality of determination elements for input images are equal to or higher than determination threshold values of the plurality of determination elements; a step of stopping the continuous shooting operation if it is determined that the determination values of the determination elements are equal to or higher than the respective determination threshold values; and a step of decreasing the determination threshold value of the corresponding determination element if it is determined that the determination value of any of the determination elements is lower than the determination threshold value of the corresponding determination element.

With this method, it is possible to provide a user-friendly photography function, and to prevent degradation of quality of a finally obtained image.

According to the present invention, there is provided a program for causing a computer to execute the steps of the photography method.

With this program, it is possible to provide a user-friendly photography function, and to prevent degradation of quality of a finally obtained image.

### Advantages of the Invention

According to the present invention, it is possible to provide a user-friendly photography function, and to prevent degradation of quality of a finally obtained image.

### BRIEF DESCRIPTION OF THE DRAWINGS

FIG. 1 is a block diagram showing an example of a structure of a photography device according to an embodiment of the invention.

FIG. 2 is a schematic view showing examples of determination values of a plurality of determination elements and determination threshold values relating to photographed images according to the embodiment of the invention.

FIG. 3 is a flowchart showing an example of a basic operation of the photography device according to the embodiment of the invention.

FIG. 4 is a flowchart showing an example of a detail process sequence of a best shot analysis process according to the embodiment of the invention.

FIG. 5 is a flowchart showing a correction process example 1 of a determination threshold value according to the embodiment of the invention.

FIG. 6 is an image diagram of examples of results of correction performed in the correction process example 1 of the determination threshold value according to the embodiment of the invention.

FIG. 7 is a flowchart showing a correction process example 2 of a determination threshold value according to the embodiment of the invention.

FIG. 8 is an image diagram of examples of results of correction performed in the correction process example 2 of the determination threshold value according to the embodiment of the invention.

FIG. 9 is a flowchart showing a correction process example 3 of a determination threshold value according to the embodiment of the invention.

FIG. 10 is an image diagram of examples of results of correction performed in the correction process example 3 of the determination threshold value according to the embodiment of the invention.

### MODE FOR CARRYING OUT THE INVENTION

An embodiment of the invention is described below in detail with reference to the accompanying drawings.

A photography device according to the embodiment of the invention is a digital camera, a digital vide camera, a mobile phone, a mobile information terminal device or the like having a continuous shooting (also referred to as rapid shooting) function. The embodiment may provide a program for causing a computer to execute thereon functions of the photography device described below.

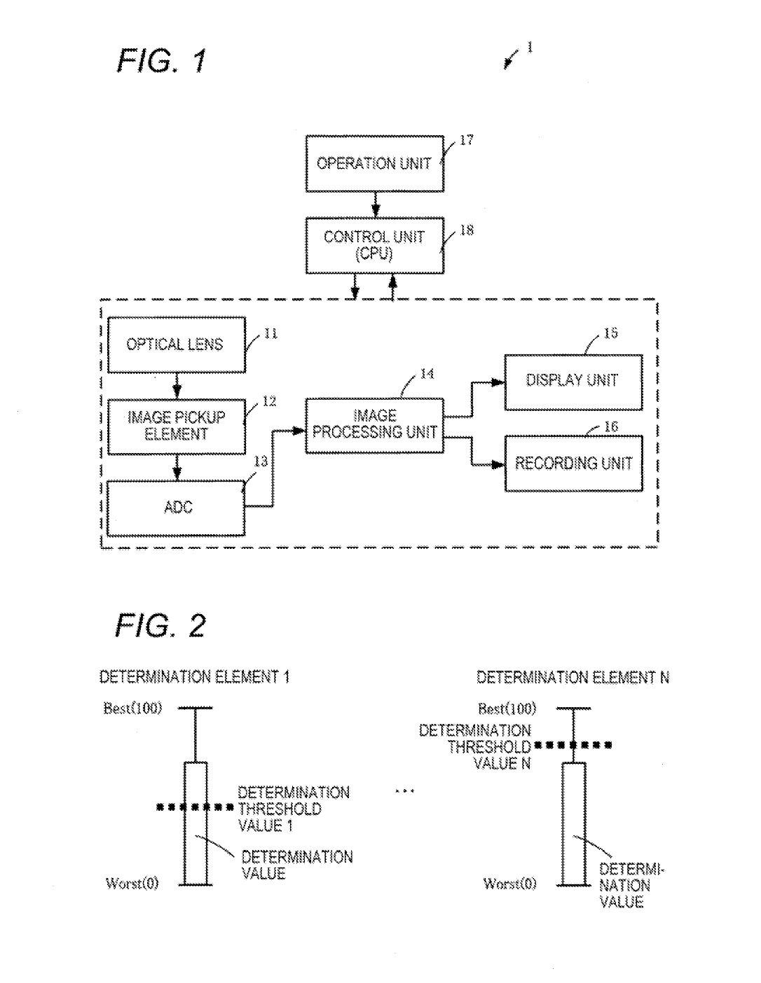

FIG. 1 is a block diagram showing an example of a structure of the photography device according to the embodiment of the invention. The photography device 1 shown in FIG. 1, includes an optical lens 11, an image pickup element 12, an ADC (Analog Digital Converter) 13, an image processing unit 14, a display unit 15, a recording unit 16, an operation unit 17 and a control unit (a CPU) 18.

The optical lens 11 is adapted to collect light from a photographic object to the image pickup element 12. The image pickup element 12 has pixels such as CODs, CMOSs or the like each having a photoelectric conversion effect arranged in a two-dimensional manner, and converts incident light from a photographic object into an electric signal so as to output an analog image signal. Therefore, the image pickup element 12 functions as an image input unit for inputting an image. The ADC 13 performs a noise suppressing process, a sample holding process, a gain controlling process and the like with respect to the analog image signal output from the image pickup element 12 so as to perform an AD converting process thereof, and then outputs digital image signals.

The image processing unit 14 performs a predetermined imaging process such as correction of a brightness and colors of a photographed image, conversion of a resolution or the like, a CODEC process for performing a predetermined coding or decoding process, a best shot analysis/determination process for analyzing or determining whether or not a photographed image is a desired image (a best shot), and a best shot determination threshold value setting process for setting a determination threshold value adapted to determine whether or not the photographed image is the desired image.

The display unit 15 is formed of an LCD (Liquid Crystal Display), a thin display panel other than that or the like and displays images and the like image-processed by the image processing unit 14. The recording unit 16 is a memory that records images and the like image-process by the image processing unit 14. Meanwhile, the recording unit 16 can be a memory provided on the photography device 1 or a detachable memory separated from the photography device 1. These memories can be used in conjunction with each other. The operation unit 17 is adapted to allow a user to carry out various kinds of operations for inputting instructions. The operation unit 17 has, for example, a shutter/release button and, a key or dial or the like for setting various kinds of settings such as an on/off setting of flashlight. In response to an operation to the operation unit 17, a control signal is input to the control unit 18. The operation unit 17 is also used for instructing start of a continuous shooting operation. The control unit 18 performs various kinds of control operations with respect to the structural units 11 to 17 of the photography device 1.

Here, the best shot analysis/determination process by the image processing unit 14 is described below.

The photography device 1 has a plurality of determination elements for determining a best shot. As the plurality of determination elements, there are, for example, a smiling face degree, a camera shake degree, a front orientation degree, a centering degree, a contrast, a brightness, a blinking degree and the like. In addition, the number of determination elements is arbitrary. Also, determination threshold values of the respective determination elements are arbitrary. For example, the determination threshold values can be made in such a manner that (a) all of them are fixed values, (b) each of them is fixed values by each of the determination elements, (c) they are set in accordance with operations of a user via the operation unit 17, or (d) they are set by the image processing unit 14 in association with a photographing mode such as a night scene mode, a landscape mode, a firework mode or the like.

The image processing unit 14 performs analyzing of images with respect to each of the determination elements (determination element 1, . . . , determination element N) by each one time of photographing in the continuous shooting operation so as to perform scoring. FIG. 2 is a schematic view showing examples of scored analysis results (determination values) of the respective determination elements. In the examples shown in FIG. 2, “Worst” indicates a score point (determination value) of 0, and “Best” indicates a score point (determination value) of 100. The determination result 1 indicates an example higher than the determination threshold value, and the determination result N indicates an example lower than the determination threshold value.

Next, a basic operation of the photography device 1 is described below.

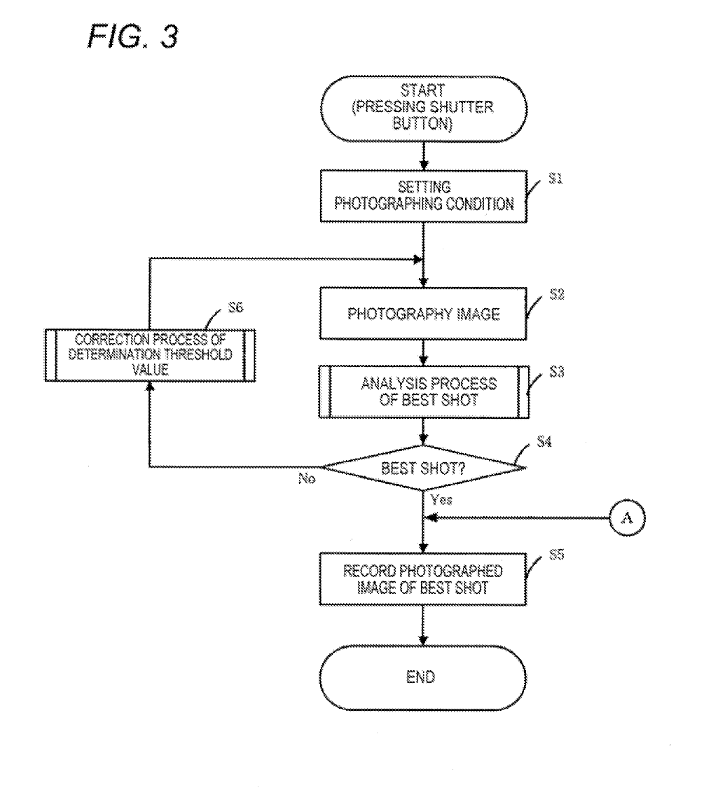

FIG. 3 is a flowchart showing the basic operation of the photography device 1. The operation in FIG. 3 is started when the control unit 18 detects that the shutter button as one example of the operation unit 17 is pressed down. In addition, it is possible that the control unit 18 sets an automatic photographing start setting so as to automatically perform starting of the photographing when, for example, the smiling face degree becomes equal to or higher than a predetermined criterion.

First, the image processing unit 14 performs setting of a photographing condition (step S1). Here, determination threshold values (initial values) for the plurality of determination elements are set. In order to set the determination threshold values, there are setting methods as the above described items (a) to (d).

Next, an image of a photographic object is photographed by means of the optical lens 11 and the image pickup element 12. The image processing unit 14 applies a predetermined imaging process, a CODEC process and the like to a photographed image via the ADC 13 (step S2).

Next, the image processing unit 14 performs a best shot analysis process (step S3). To be specific, the image processing unit 14 performs a scoring process of the plurality of determination elements relating to the photographed image as shown in FIG. 2.

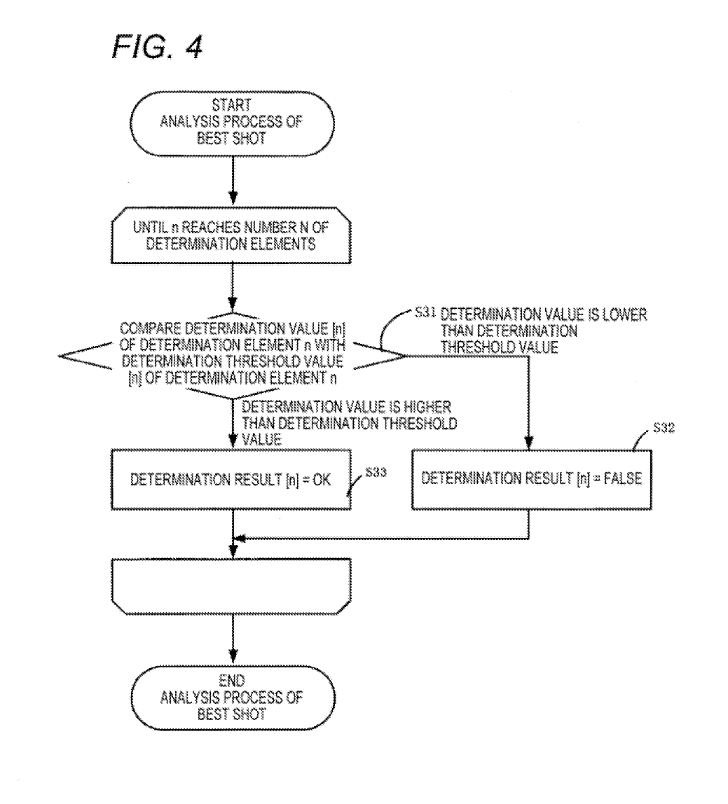

Here, FIG. 4 is a flowchart showing an example of a detail process sequence of the best shot analysis process in step S3. In the best shot analysis process, the following process is repeated until n becomes the number N of the determination elements.

First, the image processing unit 14 compares a determination value [n] of the determination element n with a determination threshold value [n] of the determination element n (step S31). In a case where the determination value [n] is lower than the determination threshold value [n] based on the result of the comparison, the image processing unit 14 sets the determination result [n] to be FALSE (step S32). Contrary to the above, in a case where the determination value [n] is higher than the determination threshold value [n], the image processing unit 14 sets the determination result [n] to be OK (step S33).

Next, the image processing unit 14 determines whether or not the photographed image is a desired image (a best shot) on the basis of the result of the best shot analysis process (step S4). For example, in a case where the determination values are higher than the determination threshold values about the plurality of determination elements, respectively, the image processing unit 14 determines that the photographed image is the best shot. In a case where even one of the determination values is lower than the determination threshold value, the image processing unit 14 determines that the photographed image is not the best shot. In other word, in a case where there is not FALSE in the determination results [n] shown in FIG. 4, the image processing unit 14 determines that the photographed image is the best shot, but in a case where there is FALSE in the determination results [n], the image processing unit 14 determines that the photographed image is not the best shot.

In the case where the photographed image is the best shot, the recording unit 16 records the photographed image (step S5). At that time, the image processing unit 14 stops the continuous shooting operation.

On the other hand, in the case where the photographed image is not the best shot, the image processing unit 14 performs a correction process of the determination threshold value with respect to at least one of the plurality of determination elements (step S6). In order to perform the best shot analysis operation at the next photographing during the continuous shooting operation by using the corrected determination threshold value, the operation is returned to step S2.

Thus, while the photography device 1 performs the correction of the determination threshold value in the case where there is not the best shot in the photographed images during the continuous shooting operation, there are some methods in the correction process of the determination threshold value, and then the methods are sequentially described below.

### Correction Process Example 1 of Determination Threshold Value

A correction process example 1 is a process in which only a determination threshold value of a determination element of which the determination value is not able to exceed the determination threshold value, is decreased, but a determination threshold value of a determination element of which the determination value exceeds the determination threshold value, is not decreased.

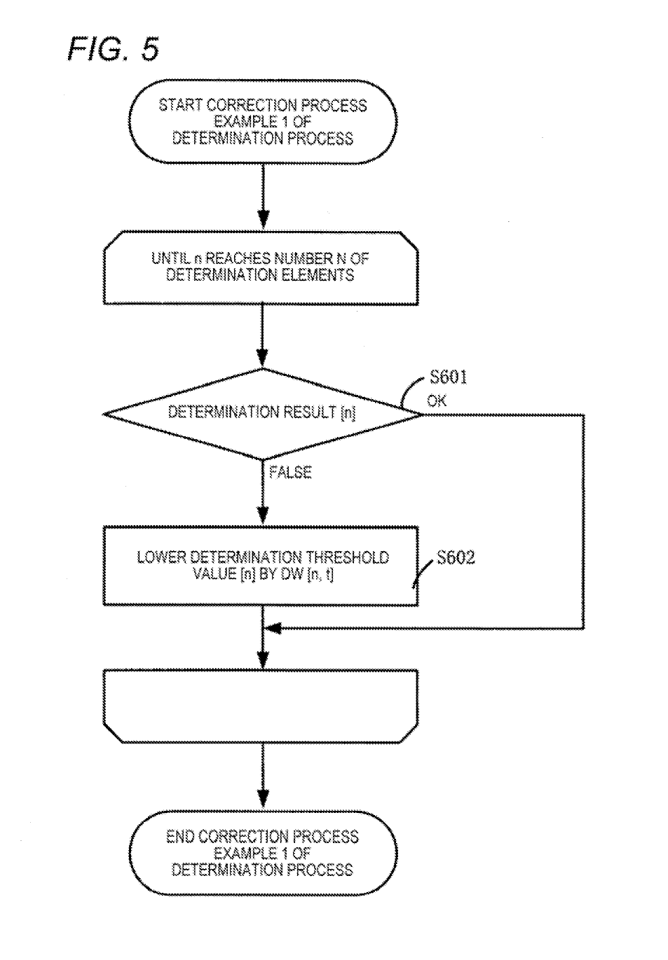

FIG. 5 is a flowchart showing the correction process example 1 of the determination threshold value in step S6 in FIG. 3. The process shown in FIG. 5 is performed in a case where a photographed image during continuous shooting operation is not the best shot (No in step S4 in FIG. 3), that is there is FALSE in the determination results [n] shown in FIG. 4.

In FIG. 5, the following process is repeated until “n” reaches the number N of the determination elements. First, the image processing unit 14 determines whether or not the determination result [n] is FALSE (step S601). When the determination result [n] is FALSE, the image processing unit 14 decreases the determination threshold value [n] by DW [n, t] (step S602). That is, the image processing unit 14 decreases the determination threshold value of the corresponding determination element in a case where the image processing unit 14 determines that any of the determination values of the determination elements is lower than the determination threshold value of the corresponding determination element. Contrary to the above, when the determination result [n] is OK, the image processing unit 14 does not change the determination threshold value [n]. After performing the correction process of the determination threshold value, the operation of the photography device 1 is returned to step S2 in FIG. 3.

Here, the DW [n, t] indicates a decrease width DW of the determination threshold value n at a time t. The decrease width DW [n, t] can be set by the image processing unit 14 by each determination element, and the image processing unit 14 can change the decrease width [n, t] in association with the photographing mode.

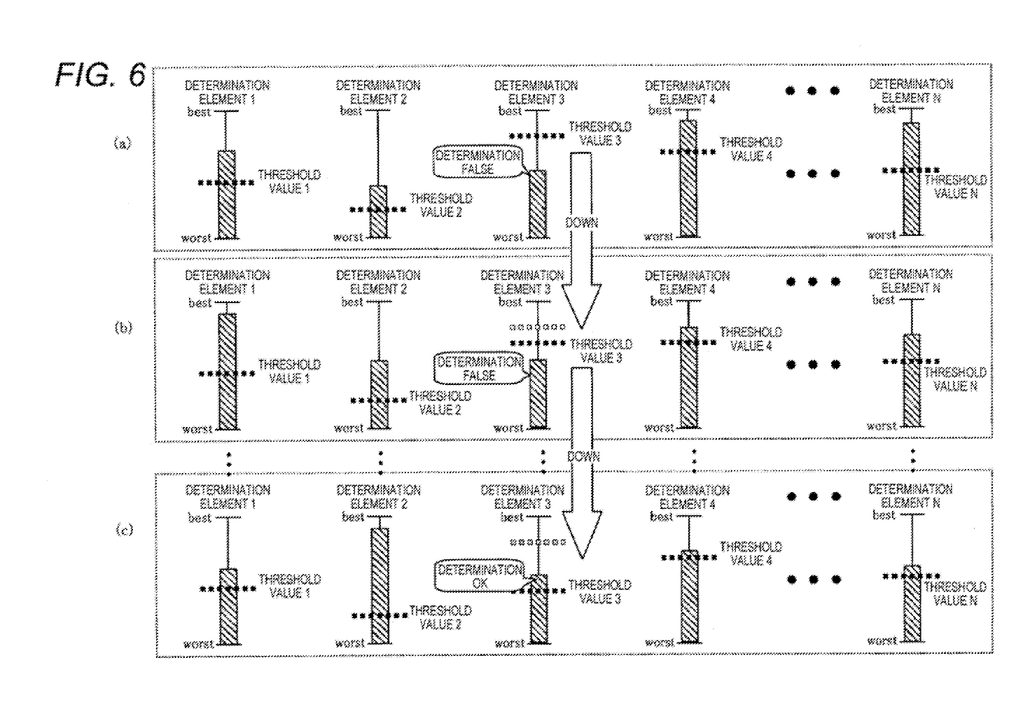

FIG. 6 is an image diagram showing examples of results of correction performed in the correction process example 1 of the determination threshold values. The threshold values described in FIG. 6 mean the determination threshold values.

First, the photography device 1 that performs the correction processing example 1 of the determination threshold value, performs first photographing of an image in a continuous shooting operation. In the first photographing during the continuous shooting operation, only a determination element 3 is a determination result FALSE as shown in FIG. 6(a). Based on the result, the image processing unit 14 decreases a determination threshold value [3] of the determination element 3. Since there is the determination result FALSE in the first photographing during the continuous shooting operation, second photographing is performed. In the second photographing during the continuous shooting operation, only the determination element 3 is the determination result FALSE similarly to the first photographing as shown in FIG. 6(b). Based on the above result, the image processing unit 14 decreases the determination threshold [3] of the determination element 3. Since there is the determination result FALSE in the second photographing during the continuous shooting operation, third photographing is performed. In the third photographing during the continuous shooting operation, all of the determination results including the determination element 3 are OK as shown in FIG. 6(c). Since there is not the determination element of the determination result FALSE in the third photographing during the continuous shooting operation, the recording unit 16 records the photographed image.

While, the example in which only one determination element (the determination element 3) is lower than the determination threshold value [n], is shown in FIG. 6, the correction process example 1 can be applied even when the plurality of determination elements are lower than the determination threshold value [n].

In accordance with the correction process example 1 of the determination threshold value, while, for example, only the determination threshold value for detection of a smiling face is decreased with respect to a photographic object which hardly becomes a smiling face, it is possible that the determination threshold values of other determination elements such as detection of camera shake, detection of a front orientation and the like are not decreased. Therefore, it is possible to prevent degradation Of quality of a best shot which may occur when the determination threshold values of the determination elements of which the determination values exceed the determination threshold values are also decreased.

### Correction Process Example 2 of Determination Threshold Value

A correction process example 2 is a process in which determination threshold values of determination elements other than a determination element of which a determination threshold value is to be decreased are increased in order to effectively use a time which may be created while the determination threshold value is decreased, so that the determination threshold values (determination criteria) of the determination elements having margins are raised.

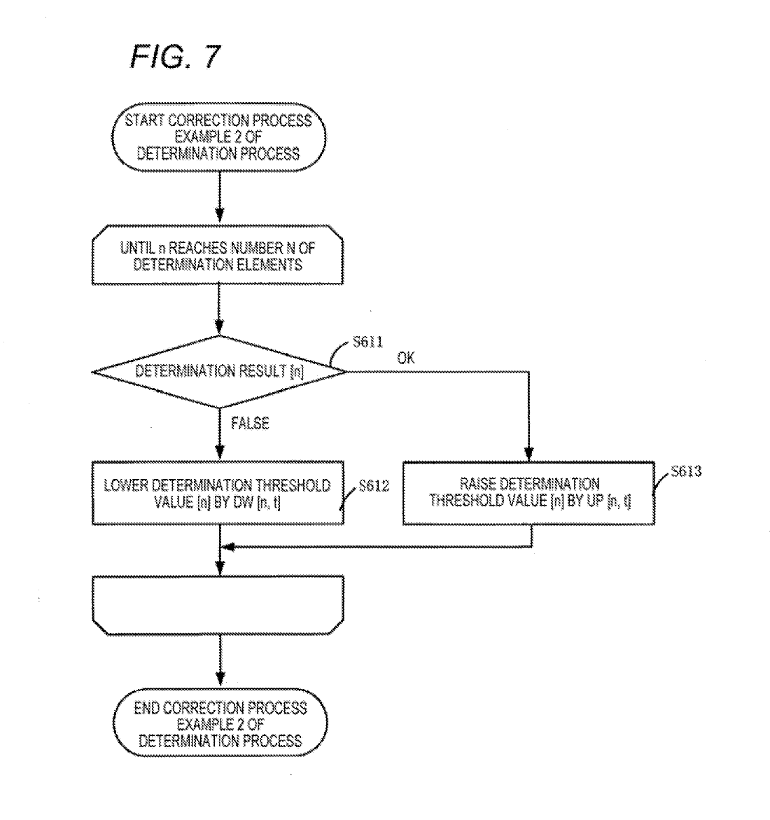

FIG. 7 is a flowchart showing the correction process example 2 of the determination threshold value in step S6 in FIG. 3. The process in FIG. 7 is performed in a case where a photographed image during a continuous shooting operation is not the best shot (No in step S4 in FIG. 3), that is, there is FALSE in the determination results [n] shown in FIG. 4.

In FIG. 7, the following process is repeated until n reaches the number N of the determination elements: First, the image processing unit 14 determines whether or not the determination result [n] is FALSE (step S611). When the determination result [n] is FALSE, the image processing unit 14 decreases the determination threshold value [n] by the DW [n, t] (step S612). Contrary to the above, when the determination result [n] is OK, the image processing unit 14 increases the determination threshold value [n] by UP [n, t] (step S613). That is, in a case where the image processing unit 14 determines that the determination value of any of the determination elements is lower than the determination threshold value of the corresponding determination element, the image processing unit 14 increases the determination threshold values of the determination elements other than the corresponding determination element. After performing the correction process of the determination threshold values, the operation of the photography device 1 returned to step S2 in FIG. 3.

Here, the UP [n, t] indicates an increase width UP of the determination threshold value n at a time t. The increase width UP [n, t] can be set by the image processing unit 14 by each determination element similarly to the case of the decrease width DW [n, t]. The image processing unit 14 can change the increase width UP in accordance with the time, and can change it in association with the photographing mode.

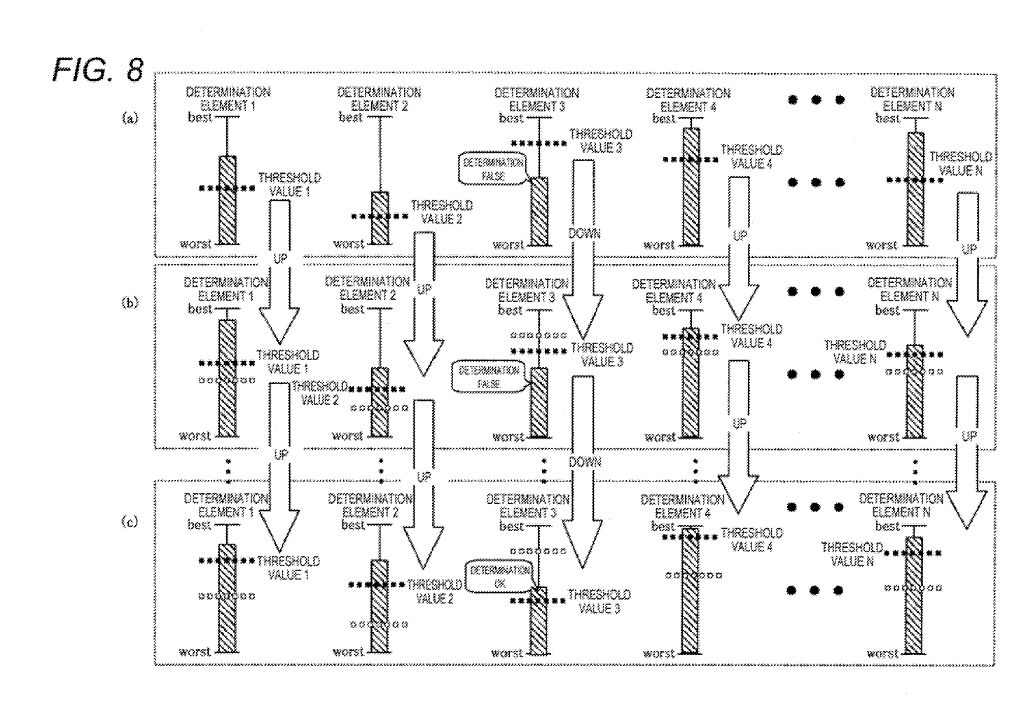

FIG. 8 is an image diagram showing examples of results of correction performed in the correction process example 2 of the determination threshold values. The values described in FIG. 8 mean the determination threshold values.

First, the photographing apparatus 1 that performs the correction process 2 of the determination threshold values, performs first photographing in a continuous shooting operation. In the first photographing during the continuous shooting operation, only the determination element is FALSE, as shown in FIG. 8(a). Based on the result, the image processing unit 14 decreases the determination threshold value [3] of the determination element 3, but increases the determination threshold values [1], [2], [4] and [5] of the determination elements 1, 2, 4 and 5 other than the above determination element [3]. Since there is the determination result FALSE in the first photographing during the continuous shooting operation, second photographing is performed. In the second photographing during the continuous shooting operation, only the determination element 3 is the determination result FALSE, similarly to the first photographing, as shown in FIG. 8(b). Based on the result, the image processing unit 14 decreases the determination threshold value [3] of the determination element 3, but increases the determination threshold values [1], [2], [4] and [5] of the determination elements 1, 2, 4 and 5 other than the above determination element [3]. Since there is the determination result FALSE in the second photographing during the continuous shooting operation, third photographing is performed. In the third photographing during the continuous shooting operation, all of the determination results including the determination element 3 are OK as shown in FIG. 8(c). Since there is not any determination element of the determination result FALSE in the third photographing during the continuous shooting operation, the recording unit 16 records the photographed image.

In accordance with the correction process example 2 of the determination threshold value, in a case where, for example, a determination value of a smiling face degree becomes equal to or higher than a determination threshold value at last and the detection of a smiling face is achieved, the determination values are higher than criteria higher than initial setting values of the determination threshold values with respect to other detection elements initially having margins such as detection of camera shake, detection of a contrast and the like, so that it is possible to more improve the quality of the best shot.

In the plurality of images photographed by the continuous shooting operation, the determination values of images photographed later are not always higher than the determination value of the image photographed before. However, since a determination element initially having a large determination value has a probability that the determination value becomes higher after that, it is possible to improve the quality of the best shot at a high probability.

### Correction Process Example 3 of Determination Threshold Value

A correction process example 3 is a process in which in a case where determination threshold values of determination elements other than a determination element of which a determination threshold value is to be decreased are increased, when the determination threshold value during the increasing exceeds an upper limit threshold value, it is determined that the photographed image is the best shot even under a condition that there is the element of which the determination value [n] of the determination element n is lower than the determination threshold value [n].

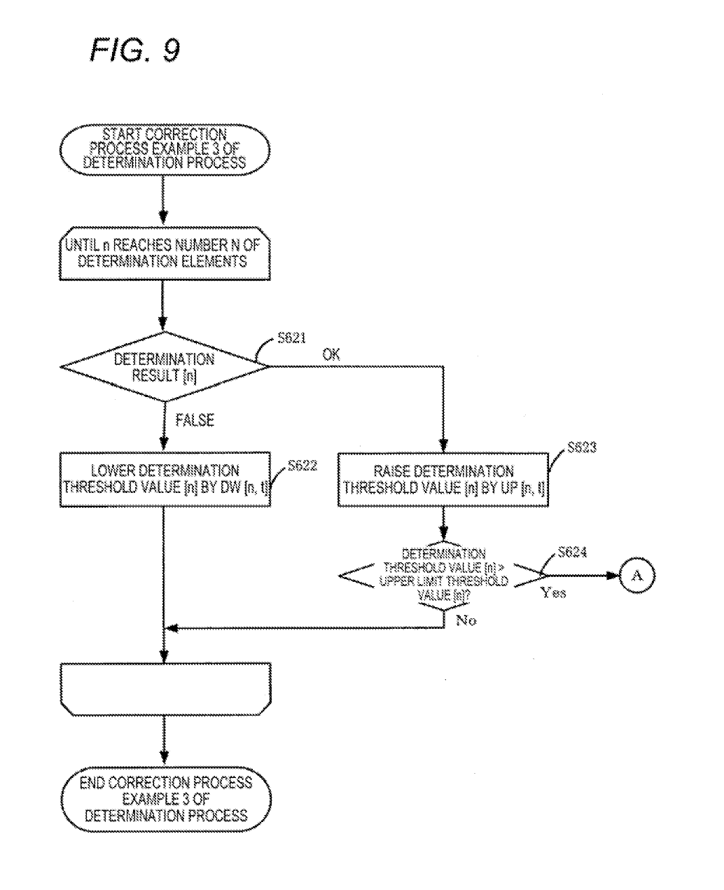

FIG. 9 is a flowchart showing the correction process example 3 of the determination threshold value in step S6 in FIG. 3. The process in FIG. 9 is performed in a case where a photographed image during a continuous shooting operation is not the best shot (No in step S4 in FIG. 3), that is, there is FALSE in the determination results [n] shown in FIG. 4.

In FIG. 9, the following process is repeated until the number N of the determination elements becomes n. First, the image processing unit 14 determines whether or not the determination result [n] is FALSE (step S621). When the determination result [n] is FALSE, the image processing unit 14 decreases the determination threshold value [n] by the DW [n, t] (step S622). Contrary to the above, when the determination result [n] is OK, the image processing unit 14 increases the determination threshold value [n] by the UP [n, t] (step S623). Then, the image processing unit 14 compares the increased determination threshold value [n] with the upper limit threshold value [n] (step S624). When the determination threshold value [n] is higher than the upper limit threshold value [n], the image processing unit 14 determines that the corresponding photographed image is the best shot and stops the continuous shooting operation, and then the recording unit 16 records the corresponding photographed image (step S5 in FIG. 3). That is, the image processing unit 14 stops the continuous shooting operation in a case where the increased determination threshold value is equal to or higher than the upper limit threshold value of the determination element of the corresponding determination threshold value. After performing the correction process of the determination threshold value, the operation of the photography device 1 is returned to step S2 in FIG. 3.

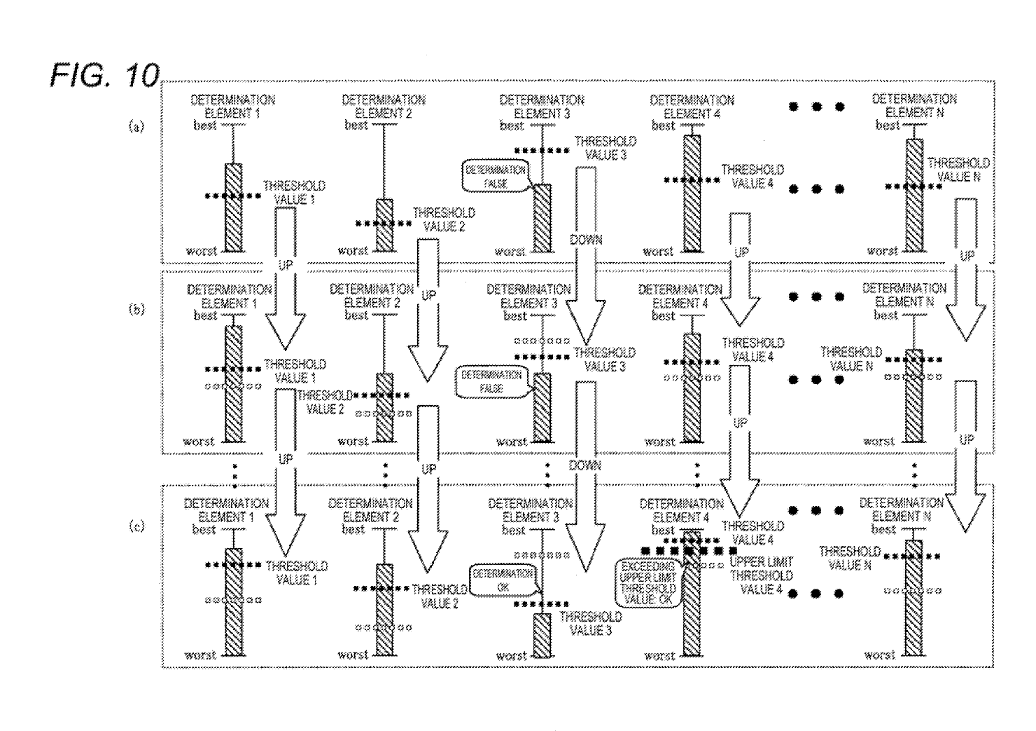

FIG. 10 is an image drawing showing examples of results of correction by the correction process example 2 of the determination threshold values. The threshold values described in FIG. 10 mean the determination threshold values.

As shown in FIGS. 10(a) and 10(b), first photographing and the second photographing during the continuous shooting operation are similar to those in FIGS. 8(a) and 8(b) described in the correction process example 2 of the determination threshold values. Since there is the determination result FALSE in the second photographing during the continuous shooting operation and any determination threshold value [n] is not higher than the upper limit threshold value [n], the third photographing is performed. In the third photographing during the continuous shooting operation, only the determination element 3 is the determination result FALSE, as shown in FIG. 8(c). However, the determination threshold value [4] is higher than the upper limit threshold value [4]. Therefore, the image processing unit 14 determines that the image photographed at the third time during the continuous shooting operation is the best shot, and the recording unit 16 records the photographed image.

In accordance with the correction process example 3 of the determination threshold value, even in a case where a determination value of a predetermined determination element is lower than the determination threshold value, when an extremely large determination value is obtained with respect to another determination element, a best shot excellent in overall quality can be obtained. In a case where, for example, a baby who hardly keeps his or her eyes front is to be photographed, a determination threshold value of determination of full-faced pose is gradually decreased. On the other hand, in a case where an extremely high smiling face degree is obtained, a best smiling face can be obtained as a best shot even when the baby does not keep his or her front.

While the invention is described in detail by referring to a specific embodiment, it is understood by those of ordinary skill in the art that various modifications and changes can be made without departing from the sprit and scope of the invention.

This application is based on Japanese Patent Application (JP-2009-228281) filed on Sep. 30, 2009, the contents of which are incorporated herein by reference.

### INDUSTRIAL APPLICABILITY

The invention is useful to a photography device that has a user friendly continuous shooting function and can prevent degradation of quality of an image lastly photographed, and a program thereof or the like.

### DESCRIPTION OF REFERENCE SIGNS

1 Photography Device

11 Optical Lens

12 Image Pickup Element

13 ADC

14 Image Processing Unit

15 Display Unit

16 Recording Unit

17 Operation Unit

18 Control Unit (CPU)

1. A photography device capable of performing a continuous shooting operation, comprising:
a continuous shooting start instruction unit configured to instruct start of the continuous shooting operation;
an image input unit configured to input images at the continuous shooting operation;
an image determination unit configured to determine whether determination values of a plurality of determination elements for images input by the image input unit are equal to or higher than determination threshold values of the plurality of determination elements;
a continuous shooting stopping control unit configured to stop the continuous shooting operation if the image determination unit determines that the determination values of the determination elements are equal to or higher than the respective determination threshold values; and
a determination threshold value correction unit configured to decrease the determination threshold value of the corresponding determination element if the image determination unit determines that the determination value of any of the determination elements is lower than the determination threshold value of the corresponding determination element.

2. The photography device according to claim 1,
wherein if the image determination unit determines that the determination value of any of the determination elements is lower than the determination threshold value of the corresponding determination element, the determination threshold value correction unit increases the determination threshold value of the determination element other than the corresponding determination element.

3. The photography device according to claim 2,
wherein the continuous shooting stopping control unit stops the continuous shooting operation if the determination threshold value increased by the determination threshold value correction unit is equal to or higher than an upper limit threshold value of the determination element of the corresponding determination threshold value.

4. A photography method capable of performing a continuous shooting operation, comprising:
instructing start of the continuous shooting operation;
inputting images at the continuous shooting operation;
determining whether determination values of a plurality of determination elements for input images are equal to or higher than determination threshold values of the plurality of determination elements;
stopping the continuous shooting operation if it is determined that the determination values of the determination elements are equal to or higher than the respective determination threshold values; and
decreasing the determination threshold value of the corresponding determination element if it is determined that the determination value of any of the determination elements is lower than the determination threshold value of the corresponding determination element.

5. A computer-readable medium having a program stored thereon and readable by a computer, said program, when executed by the computer, causing the computer to execute the photography method according to claim 4.
